(19) United States
(12) Patent Application Publication
(10) Pub. No.: US 2007/0141407 A1
(43) Pub. Date: Jun. 21, 2007

(54) Fuel cell exhaust gas burner

(76) Inventors: Christopher J. Chuah, Clifton Park, NY (US); Mihail Penev, Albany, NY (US)

Correspondence Address: TROP PRUNER & HU, PC, 1616 S. VOSS ROAD, SUITE 750, HOUSTON, TX, 77057-2631, US

(21) Appl. No.: 11/311,695

(22) Filed: Dec. 19, 2005

(51) Int. Cl. H01M 8/04; F23D 14/62

(52) U.S. Cl. 429/13; 429/26; 431/354

(57) ABSTRACT

A technique that is usable with a fuel cell stack includes combining a fuel flow with an oxidant in a mixer to create a substantially funnel-shaped flow, which is ignited.

### GOVERNMENT LICENSE RIGHTS

The U.S. Government has a paid-up license in this invention and the right in limited circumstances to require the patent owner to license others on reasonable terms as provided for by the terms of Contract No. 70NANB1H3065 awarded by the National Institute of Standards and Technology.

### BACKGROUND

The invention generally relates to a fuel cell exhaust gas burner and more particularly relates to a mixing design for the burner.

A fuel cell is an electrochemical device that converts chemical energy directly into electrical energy. For example, one type of fuel cell includes a proton exchange membrane (PEM), which permits only protons to pass between an anode and a cathode of the fuel cell. Typically PEM fuel cells employ sulfonic-acid-based ionomers, such as Nafion, and operate in the 60° Celsius (C.) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many subsystems of a typical fuel cell system, as the fuel cell system may include (as examples) a cooling subsystem, a cell voltage monitoring subsystem, a control subsystem, a power conditioning subsystem, etc. The particular design of each of these subsystems is a function of the application that the fuel cell system serves.

The anode exhaust (also called “tailgas”) from the fuel cell stack typically contains residual fuel and other emissions, which cannot be released directly into the surrounding environment. Therefore, the fuel cell system may include a burner, a device that mixes the anode exhaust gas with an oxidant (air, for example) and combusts the resultant mixture. The mixture that combusts inside the burner typically contains a combination of carbon monoxide, oxygen, hydrogen and one or more hydrocarbons; and for purposes of ensuring proper combustion, the mixture must be kept at a combustion temperature (a temperature of approximately 900° C., for example) for a certain amount of time. The time depends on how well the anode exhaust and the oxidant mix, as the better the mixture, the smaller the amount of time that is needed for combustion. A smaller time for combustion, in turn, typically simplifies the overall surface area needed for combustion, decreases the ambient heat loss and increases the overall efficiency of the burn.

Thus, there exists a continuing need for a burner with an improved mixing capability.

### SUMMARY

In an embodiment of the invention, a technique that is usable with a fuel cell stack includes combining a fuel flow with an oxidant in a mixer to create a substantially funnel-shaped flow, which is ignited.

In another embodiment of the invention, a burner includes a mixer and an igniter. The mixer is adapted to combine an exhaust flow from a fuel cell with an oxidant to create a substantially funnel-shaped flow. The igniter ignites the substantially funnel-shaped flow.

In yet another embodiment of the invention, a fuel cell system includes a mixer and a fuel cell stack to produce an exhaust flow. The mixer is adapted to combine the exhaust flow with an oxidant to create a substantially funnel-shaped flow.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a flow diagram depicting a technique to combust an anode exhaust flow with an oxidant according to an embodiment of the invention.

FIG. 3 is a schematic diagram of a burner according to an embodiment of the invention.

FIG. 4 illustrates oxidant and fuel flows inside a mixing chamber of the burner according to an embodiment of the invention.

FIG. 5 is a cross-sectional view of the mixing chamber taken along line 5-5 of FIG. 3 according to an embodiment of the invention.

FIG. 6 is a cross-sectional view of an exemplary port of the burner according to an embodiment of the invention.

### DETAILED DESCRIPTION

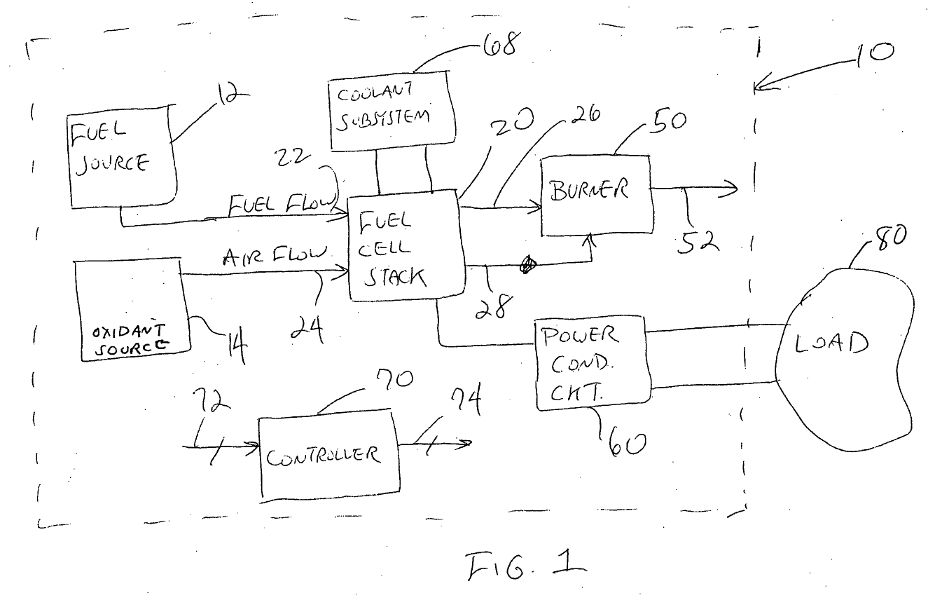

Referring to FIG. 1, a fuel cell system 10 in accordance with an embodiment of the invention includes a fuel cell stack 20 that receives fuel and oxidant flows into its anode and cathode chambers, respectively. These flows promote electrochemical reactions (see Eqs. 1 and 2 above) inside the fuel cell stack 20 to produce electricity for a load 80 of the fuel cell system 10. More particularly, the fuel cell stack 20 may include an anode inlet 22 that receives a fuel flow (a hydrogen or a reformate flow, as examples) from a fuel source 12, such as a hydrogen tank or a reformer. The fuel cell stack 20 also includes a cathode inlet 24 that receives the oxidant flow from an oxidant source 14, such as an air blower, for example.

The fuel cell stack 20 does not consume all of the fuel from the incoming fuel flow. As a result, an anode exhaust flow (alternatively called “tailgas”) that exits the fuel cell stack 20 at an anode exhaust outlet 26 of the stack 20 may contain residual fuel as well as other emissions. More specifically, the anode exhaust flow may contain hydrogen, carbon monoxide and hydrocarbons. For purposes of reducing the emissions from the fuel cell system 10, the system 10 includes a burner 50 that combusts the anode exhaust flow with an oxidant for purposes of producing a cleaner flow that exits an exhaust outlet 52 of the burner 50. As a more specific example, the burner 50 may combust, in accordance with some embodiments of the invention, the anode exhaust from the fuel cell stack 20 with a cathode exhaust flow that leaves the stack 20 at a cathode exhaust outlet 28 of the stack 20. As described in more detail below, the burner 50 has a mixer that, as compared to conventional mixers, reduces the time needed to mix the anode exhaust and oxidant flows. As a result, the burner 50 has a decreased overall surface area, a decreased ambient heat loss and an increased heat efficiency, as compared to conventional burners. Furthermore, the mixing that is achieved by the burner 50 ensures complete combustion and low emissions from the fuel cell system 10.

FIG. 1 is merely an example of one out of many possible embodiments of a fuel cell system that incorporates the burner 50. For example, although the anode exhaust flow is not recirculated to the anode inlet 22 in the fuel cell system 10, it is noted that in accordance with other embodiments of the invention, a fuel cell system 10 may include a recirculation blower (as an example) or other feedback mechanism to establish a circulation path to the anode inlet 22. As an example of another variation, in accordance with other embodiments of the invention, a bleed flow (established by an orifice) may exist between the anode exhaust outlet 26 and the anode inlet 22. As yet another example, in accordance with some embodiments of the invention, the anode chamber of the fuel cell stack 20 may be “dead-headed,” and a relatively small bleed flow may form the anode exhaust flow to the burner 50. Furthermore, in accordance with some embodiments of the invention, the cathode path of the fuel cell stack 20 may be recirculated. Thus, many variations of a fuel cell system that incorporates the burner 50 are possible and are within the scope of the appended claims.

Among other potential features of the fuel cell system 10, in accordance with some embodiments of the invention, the system 10 includes power conditioning circuitry 60 that conditions the power that is provided by the fuel cell stack 20 into the appropriate form for the load 80. For example, in accordance with some embodiments of the invention, the power conditioning circuitry 60 may include a DC-to-DC converter to regulate the DC stack voltage to a different regulated DC voltage. This DC voltage may be furnished directly to the load 80 (for the embodiments in which the load 80 is a DC load); or, in accordance with other embodiments of the invention, the power conditioning circuitry 60 may include an inverter for purposes of forming an AC voltage for the load 80. Thus, many variations and designs for the power conditioning circuitry 60 are possible and are within the scope of the appended claims.

The fuel cell system 10 may also include a temperature regulation system, such as a coolant subsystem 68, which regulates the temperature of the fuel cell stack 20. Additionally, the fuel cell system 10 may include a controller 70 that includes input lines 72 for purposes of receiving commands, voltages, currents and various status signals from controllers, measurement circuits, sensors, etc. and output terminals 74 for purposes of controlling motors and valves, communicating commands, etc.

In accordance with embodiments of the invention, the burner 50 has a mixer chamber into which the incoming anode exhaust and oxidant flows are introduced at orientations to create a funnel-shaped mixture, or “tornado,” inside the mixing chamber. More specifically, where first introduced into the mixing chamber, the anode exhaust and oxidant flows are both counter and perpendicular to each other. These orientations and flow directions produce the resultant funnel-shaped flow mixture. The funnel-shaped flow mixture, in turn, ensures that the gases mix within the smallest length possible, thereby decreasing the size and increasing the efficiency of the burner 50, as compared to conventional burners.

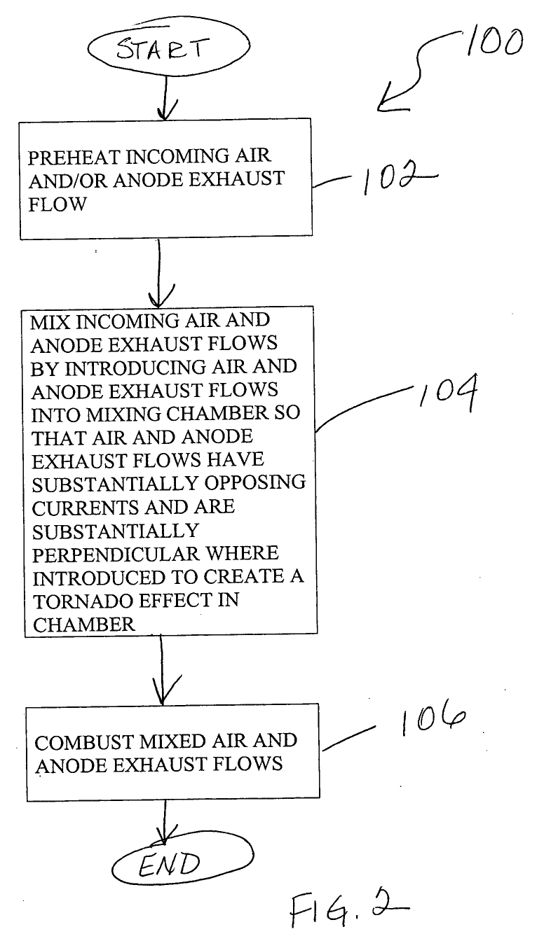

Referring to FIG. 2, in accordance with some embodiments of the invention, a technique 100 may be used in connection with the burner 50. Pursuant to the technique 100, either or both of the incoming oxidant and incoming anode exhaust flows are preheated, pursuant to block 102. The preheating allows for the reactants entering the mixing chamber to be at a temperature, which is closer to the temperature needed for combustion of the mixture. The incoming oxidant and anode exhaust flows are then mixed (block 104) by introducing the oxidant and fuel flows into a mixing chamber so that the oxidant and anode exhaust flows have substantially opposing currents and are substantially perpendicular where introduced in the missing chamber to create a tornado effect in the chamber. The funnel-shaped flow is then combusted, as depicted in block 106.

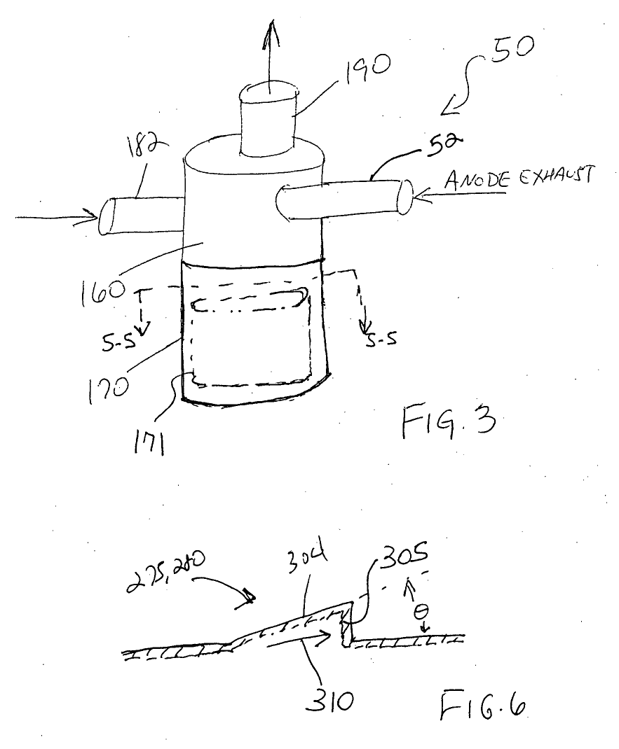

As a more specific example, FIG. 3 depicts an embodiment of the burner 50 in accordance with some embodiments of the invention. Among its other features, the burner 50 includes a mixer 170 that contains a mixing chamber 171, which is further described below. The burner 50 also includes an exhaust section 160 that may contain a catalyst to facilitate the combustion. The burner 50 includes an anode exhaust inlet 180 and an oxidant inlet 182. One or both of the incoming anode exhaust and oxidant flows may be routed through the exhaust section 160 for purposes of preheating the incoming flow(s). The incoming flows are routed to the mixer 170 and introduced into the mixing chamber 171 to create the substantially funnel-shaped mixed flow, which is ignited by an igniter (not depicted in FIG. 3) inside the mixing chamber 171. The exhausted gas passes through the exhaust section 160 and through the exhaust outlet 190 of the burner 50.

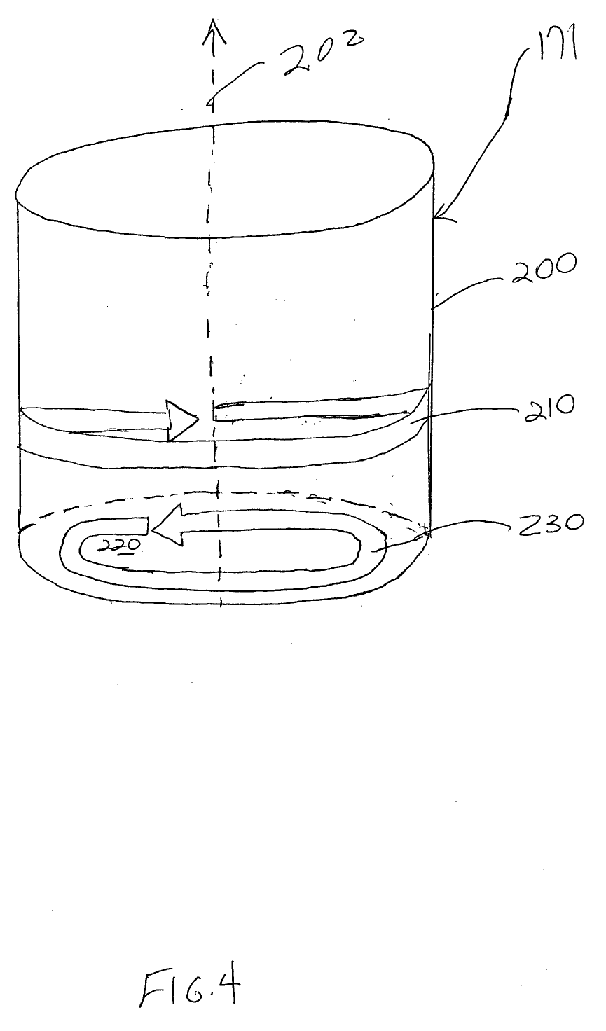

The mixing chamber 171 is schematically depicted in FIG. 4 to illustrate the mixing of the anode exhaust and oxidant flows. The mixing chamber 171 may be conceptualized as a general circular cylinder that extends around a longitudinal axis 202. Thus, in accordance with some embodiments of the invention, the mixing chamber 171 may be represented by a surface 200 that generally circumscribes the longitudinal axis 202. Furthermore, the mixing chamber 171 includes a bottom surface 220 that generally is transverse to the longitudinal axis 202. Ports (further described below) introduce a flow 210 (i.e., either the oxidant flow or the anode exhaust flow) in a clockwise direction about the longitudinal axis 202 and introduce the other flow 230 (the other of the anode exhaust flow and the oxidant flow) in a counterclockwise direction about the longitudinal axis 202. Thus, the flows 210 and 230 have counter currents.

Additionally, the flows 210 and 230, when introduced into the mixing chamber 171, are generally substantially perpendicular to each other. More specifically, in accordance with some embodiments of the invention, the flow 230 is initially introduced in an orientation such that the flow 230 is generally planar and located near the bottom surface 220 of the mixing chamber 171. The flow 210 is initially introduced into the mixing chamber 171 in an orientation such that the flow 210 is generally tangential to the longitudinal axis 202 and generally follows the surface 200.

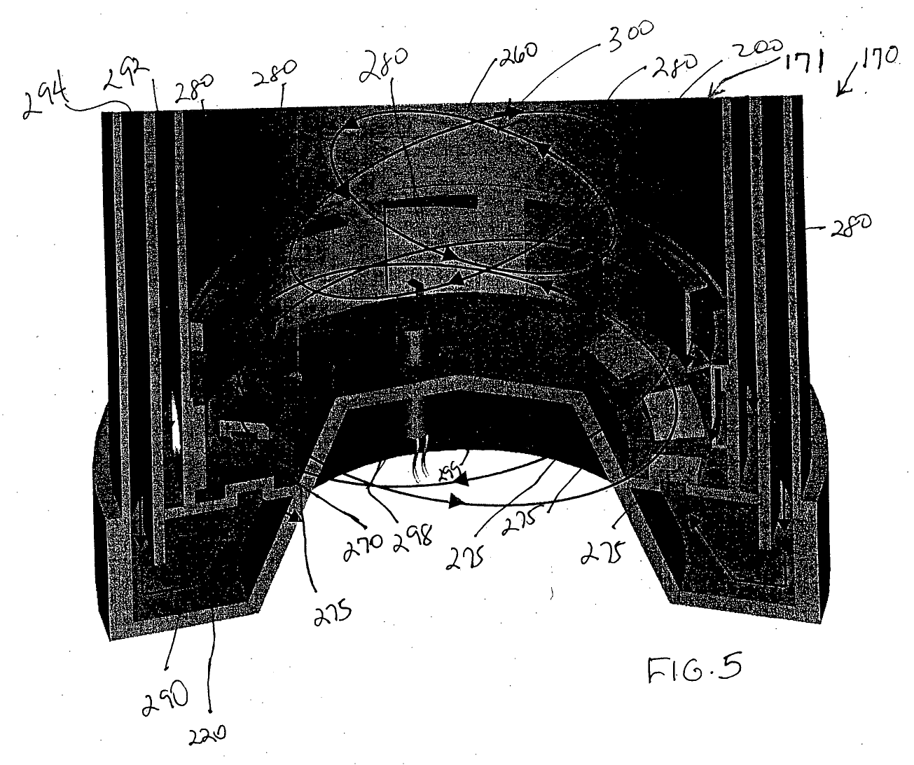

FIG. 5 depicts a cross-section of the mixer 170 (taken along line 5-5 of FIG. 3) in accordance with some embodiments of the invention. The mixer 170 includes ports 275 that breach a bottom surface 220 of the mixing chamber 171 for purposes of introducing the flow 230 (see also FIG. 4). The ports 275 are inclined and receive an incoming air flow from a chamber 290 that is located beneath the surface 220. As depicted in FIG. 5, in accordance with some embodiments of the invention, the chamber 290 receives the incoming flow via an annular passageway 294 that communicates an incoming flow from either the anode exhaust 180 or the oxidant 182 inlets.

The mixing chamber 170 also includes ports 280 that breach the surface 200 for purposes of the introducing the flow 210 into the mixing chamber 171. As shown in FIG. 5, the ports 280 are generally distributed around the surface 200. The ports 280 receive the incoming flow from an annular passageway 292 that radially extends inside the annular passageway 294 and is separated by a wall in some embodiments of the invention.

The introduction of the flows 210 and 230 into the mixing chamber 171 produces a substantially funnel-shaped flow 300. As also depicted in FIG. 5, in accordance with some embodiments of the invention, the mixer 170 includes an igniter 298 that extends above a raised center portion 299 of the lower surface 220 for purposes of igniting the flow 300.

Referring to FIG. 6, in accordance with some embodiments of the invention, the port 275, 280 may include an inclined section 304 that has an opening 305 for purposes of communicating a flow 310. The inclined section 305 maybe inclined at an angle (called “θ”) with respect to the surface that immediately surrounds the port, and the θ angle may vary between ten to thirty degrees (as an example), in some embodiments of the invention. The ports 275 and 280 may have different sized openings 305 and may have different angles, depending on the particular embodiment of the invention. Other variations and angles are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
combining an anode exhaust flow and an oxidant in a mixer to create a substantially funnel-shaped flow; and
igniting said substantially funnel-shaped flow.

2. The method of claim 1, wherein the act of combining comprises:
introducing the anode exhaust flow and the oxidant flow into the mixer so that the anode exhaust flow and the oxidant flow enter a mixing chamber of the mixer oriented in substantially opposite directions.

3. The method of claim 2, wherein the mixer comprises a mixing chamber having a longitudinal axis, and the act of introducing comprises:
introducing the anode exhaust flow into the mixing chamber so that the anode exhaust flow has a first rotational direction about the longitudinal axis; and
introducing the oxidant flow into the mixing chamber so that the oxidant flow has a second rotational direction about the longitudinal axis, the first rotational direction being substantially counter to the second rotational direction.

4. The method of claim 2, wherein the mixing chamber comprises an approximate cylinder having a first surface that circumscribes a longitudinal axis of the cylinder and a second surface that intersects the longitudinal axis, and the act of introducing comprises:
introducing the fuel and oxidant flows into the mixing chamber so that one of the fuel and oxidant flows initially follows the first surface and the other one of the anode exhaust and oxidant flows is directed initially follows the second surface.

5. The method of claim 4, wherein the act of combining comprises:
introducing said one of the fuel and oxidant flows that initially follows the first surface through ports that breach the first surface.

6. The method of claim 5, wherein at least one of the ports has an angle less than approximately thirty degrees with respect to a tangent to the longitudinal axis.

7. The method of claim 4, wherein the act of combining comprises:
introducing said one of the fuel and oxidant flows that initially follows the second surface through ports that breach the second surface.

8. The method of claim 7, wherein at least one of the ports has an angle less than approximately thirty degrees with respect to a plane that contains the second surface.

9. The method of claim 1, wherein the mixer comprises a mixing chamber defined by different surfaces that are nonplanar with respect to each other, and the act of combining comprises introducing the fuel and oxidant flows through ports that are breach the different surfaces.

10. The method of claim 1, further comprising:
adding thermal energy to at least one of the fuel and oxidant flows after said at least one of the fuel and oxidant flows exits the fuel cell stack and before said at least one of the fuel and oxidant flows enters the mixer.

11. A burner usable with a fuel cell stack, the burner comprising:
a mixer adapted to combine an anode exhaust flow and an oxidant to create a substantially funnel-shaped flow; and
an igniter to ignite said substantially funnel-shaped flow.

12. The burner of claim 11, wherein the mixer comprises:
a mixing chamber; and
ports to introduce the anode exhaust flow and the oxidant flow into the mixing chamber so that the anode exhaust flow and the oxidant flow enter the chamber oriented in substantially opposite directions.

13. The burner of claim 12, wherein
the mixing chamber having a longitudinal axis, and
the ports are adapted to introduce the anode exhaust flow into the mixing chamber so that the anode exhaust flow has a first rotational direction about the longitudinal axis and the oxidant flow has a second rotational direction about the longitudinal axis, the first rotational direction being substantially counter to the second rotational direction.

14. The burner of claim 12, wherein
the mixing chamber comprises a cylinder having a first surface that circumscribes a longitudinal axis of the cylinder and a second surface that intersects the longitudinal axis, and
the ports are adapted to introduce the fuel and oxidant flows into the mixing chamber so that one of the fuel and oxidant flows initially follows the first surface and the other one of the fuel and oxidant flows is directed initially follows the second surface.

15. The burner of claim 14, wherein at least some of the ports breach the first surface.

16. The burner of claim 15, wherein said at least one of the ports each has an angle less than approximately thirty degrees with respect to a tangent to the longitudinal axis.

17. The burner of claim 14, wherein at least some of the ports breach the second surface.

18. The burner of claim 17, wherein at least one of the ports has an angle less than approximately thirty degrees with respect to a plane that contains the second surface.

19. The burner of claim 12, wherein the mixer comprises a mixing chamber defined by different surfaces that are nonplanar with respect to each other, the burner further comprising:
ports to introduce the fuel and oxidant flows, the ports breaching the different surfaces.

20. A fuel cell system comprising:
a fuel cell stack to produce an exhaust fuel flow; and
a mixer adapted to combine the exhaust fuel flow with an oxidant to create a substantially funnel-shaped flow.

21. The fuel cell system of claim 20, wherein the mixer comprises:
a mixing chamber; and
ports to introduce the anode exhaust flow and the oxidant flow into the mixing chamber so that the anode exhaust flow and the oxidant flow enter the chamber oriented in substantially opposite directions.

22. The fuel cell system of claim 21, wherein
the mixing chamber having a longitudinal axis, and
the ports are adapted to introduce the anode exhaust flow into the mixing chamber so that the anode exhaust flow has a first rotational direction about the longitudinal axis and the oxidant flow has a second rotational direction about the longitudinal axis, the first rotational direction being substantially counter to the second rotational direction.

23. The fuel cell system of claim 21, wherein
the mixing chamber comprises a cylinder having a first surface that circumscribes a longitudinal axis of the cylinder and a second surface that intersects the longitudinal axis, and
the ports are adapted to introduce the fuel and oxidant flows into the mixing chamber so that one of the fuel and oxidant flows initially follows the first surface and the other one of the fuel and oxidant flows is directed initially follows the second surface.
